(19) United States
(12) Patent Application Publication
(10) Pub. No.: US 2013/0109105 A1
(43) Pub. Date: May 2, 2013

(54) INFRARED EMISSION SPECTROSCOPY OF SAMPLES WITH TIME DEPENDENT INFRARED EMISSION

(71) Applicants: Scott Jones, Landenberg, PA (US); John Rabolt, Greenville, DE (US); Bruce Chase, Newark, DE (US); James Malone, Newark, DE (US); Daniel Frost, Bear, DE (US)

(72) Inventors: Scott Jones, Landenberg, PA (US); John Rabolt, Greenville, DE (US); Bruce Chase, Newark, DE (US); James Malone, Newark, DE (US); Daniel Frost, Bear, DE (US)

(21) Appl. No.: 13/280,391

(22) Filed: Oct. 25, 2011

Related U.S. Application Data
(60) Provisional application No. 61/407,252, filed on Oct. 27, 2010.

(51) Int. Cl. G01J 3/28

(52) U.S. Cl. CPC G01J 3/2803
USPC 436/171; 250/339.02

(57) ABSTRACT

The present invention relates to carrying out infrared emission spectroscopic measurements using a sample directly or a substrate, on which a sample is placed, coated, spun-on, deposited or in some way attached, as an external source to produce a time dependent infrared emissive signature from said sample or substrate with a subsequent analysis of this signature by an infrared spectrograph equipped with a focal plane array detector.

### CROSS REFERENCE TO RELATED APPLICATIONS

This application claims priority to U.S. Provisional Application Ser. No. 61/407,252, filed Oct. 27, 2010, which is incorporated herein, in its entirety, by reference.

### TECHNICAL FIELD OF THE INVENTION

The present invention relates to the use of a sample or a substrate on which a sample is placed, coated, spun-on, deposited or in some way attached as an external source to produce a time dependent infrared emissive signature from said sample or substrate with a subsequent analysis of this signature by an infrared spectrograph equipped with a focal plane array detector.

### BACKGROUND OF THE INVENTION

Infrared emission spectroscopy (IRES) is an important technique in fields such as astronomy and astrophysics,^{1, 2} and for the standoff analysis of plumes of pollutants or potential threats in the context of military operations or homeland security.³ IRES also finds uses in laboratory settings, for instance for studying thermally excited materials or chemically excited species during reactions.⁴⁻⁷ Transient emission infrared spectroscopy (TIRS) has also been used for on-line monitoring of industrial processes.⁸⁻¹⁰

Emission and absorption spectroscopies are related through Kirchhoff's law, which states that the emittance (E) of a sample is equal to its absorbance (A).¹¹ For any non-scattering material, the sum of the emittance (or absorbance), transmittance (T), and reflectance (R) is equal to unity: ε_{(ν)}+τ_{(ν)}+ρ_{(ν)}=1. For a perfect blackbody material, α_{(ν)}=ε_{(ν)}=1 and iτ_{(ν)}=ρ_{(ν)}=0, so that no sample can emit more light, at any wavelength, than a perfect blackbody. In contrast, a perfectly reflective metal has ρ_{(ν)}=1 and thus does not contribute to the luminance spectrum, while an ideal transparent material does not emit because its transmittance is unity. Most real materials lie between these extreme cases. For thin or dilute samples, α_{(ν)} and ε_{(ν)} vary between 0 and 1 and are wavelength-dependant, thus enabling the measurement of characteristic absorption or emission spectra.

As in the case of absorption IR spectroscopy, most applications of IRES spectroscopy rely on the use of Fourier transform IR (FT-IR) interferometers. FT-IR spectroscopy provides well-documented advantages as compared to single channel dispersive instrumentation: the multichannel, high throughput, and frequency precision advantages. Commercial FT-IR spectrometers are often available with input beam ports that allow collection of IRES spectra, but they suffer from some limitations. For instance, FT-IR spectrometers use an interferometer that is sensitive to strong mechanical vibrations or shocks, which can limit their applicability for challenging field applications. In addition, recording low intensity emission spectra generally requires a long acquisition time, a limiting factor for studies of transient species and for kinetics studies. Even if the signal is very intense, it is still necessary to perform a full moving-mirror scan in order to obtain a spectrum. This not only limits the accessible time resolution but also requires the assumption that no spectral changes occur during the scan.¹² Another major limitation when using Fourier transform instruments is that the emission flux must be constant in time. Any time dependence of the emission within the Fourier frequencies of the FT-IR will cause significant degradation of the signal to noise in the measurement.

Our invention solves this problem and relates to the use of time dependent sources of radiation, for example, a thin filmsample instantaneously heated by a laser pulse, which can be detected and the subsequent time dependent, chemical and/or physical phenomena investigated using an ultrfast, no-moving parts spectrograph attached to a high speed array detector.

### BRIEF DESCRIPTION OF THE FIGURES

FIG. 1: Spectral images of a polystyrene film recorded in A) the absorption mode and B) the emission mode at 120° C. The horizontal axis covers the 1750 cm⁻¹ to 1000 cm⁻¹ range, and light tones indicate high infrared radiation intensity. C) Comparison of the absorptance (dashed line) and emittance calculated using a blackbody spectrum recorded at either 120° C. (full line) or 150° C. (dotted line) for the emittance spectra.

FIG. 2: Emittance spectra of a polystyrene film recorded at temperatures from 60 to 120° C.

FIG. 3: Emittance spectra of a polystyrene film recorded at 120° C. with acquisition times ranging from 870 to 17.4 ms.

### DETAILED DESCRIPTION OF THE INVENTION

Recently, we have combined a 2-dimensional focal plane array (FPA) infrared camera with an infrared spectrograph in a so-called planar array infrared (PA-IR) spectrometer.^{13, 14} This instrument can record 700 cm⁻¹ regions of the infrared spectrum across the 4000-950 cm⁻¹ range with a 2-10 ms time resolution. The PA-IR measurement, which is a multichannel measurement as opposed to a multiplex measurement obtained with an FT-IR, is by its very nature not affected by a time dependence in the infrared flux being measured. Another potential advantage of PA-IR spectroscopy for time dependent emission measurements is that it can be constructed as a no-moving parts instrument, making it much less sensitive to harsh environments than FT-IR interferometers.

The PA-IR spectrograph used in this work was adapted from that described in detail previously.¹³ and contained in U.S. Pat. No. 6,784,428 (Rabolt) and U.S. Pat. No. 6,943,353 (Elmore). This spectrograph contains an adjustable slit, a dispersive (prism or grating) element and a two dimensional infrared focal plane array detector. Time-dependent emission measurements can be performed by replacing the infrared source with the sample to be studied. For example, IRES spectra of thin polymer films, either self-supporting, supported or deposited on a substrate, can be recorded using a transmission heated cell (ThermoElectron, Waltham, Mass.), which allows precise temperature control from room temperature up to 200° C. or alternatively heated with a sudden “temperature-jump” by subjecting the sample to a sudden heat pulse.

Spectrum calculation: The emittance of a sample at a temperature T₁ can, in principle, be simply determined as the ratio of the luminance of a sample, L_{S}(ν, T₁), over that of a reference blackbody, L_{B}(ν, T₁), at the same temperature. In practice, it is necessary to take into account the response function of the spectrometer and the stray light originating from the different parts of the instrument when a liquid nitrogen-cooled detector is used.¹¹ This is generally accomplished by measuring the luminance of the sample and of the reference blackbody at a second (lower) temperature, T₂. Finally, it is common practice in PA-IR spectroscopy to record a dark background spectrum, D(ν), which is the spectrum obtained when the entrance slit of the monochromator is closed, in order to correct for stray light reaching the FPA (sensitive to DC light from the environment) and for any offset in the response of individual camera pixels. The final emission spectrum of a sample at temperature T₁ is thus calculated as:

$$ɛ ( v ) = \frac{[ {L}_{S} ( v , {T}_{1} ) - {D}_{S} ( v , {T}_{1} ) ] - [ {L}_{S} ( v , {T}_{2} ) - {D}_{S} ( v , {T}_{2} ) ]}{[ {L}_{B} ( v , {T}_{1} ) - {D}_{B} ( v , {T}_{1} ) ] - [ {L}_{B} ( v , {T}_{2} ) - {D}_{B} ( v , {T}_{2} ) ]}$$

Because the dark background correction is applied on both the sample and blackbody spectra, the emission spectrum is almost identical whether the measurements at temperature T₂ are considered or not.

### Experimental Results

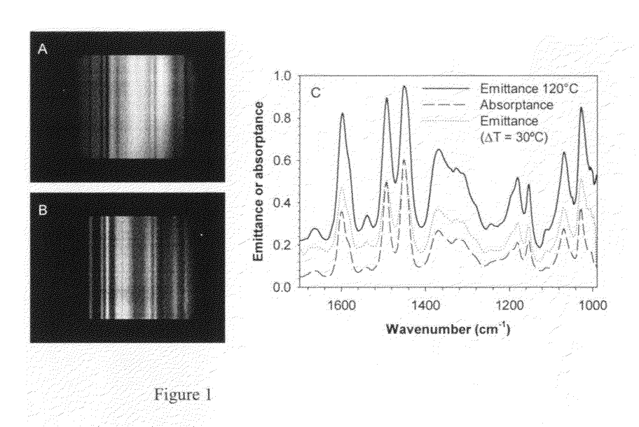

FIG. 1 shows spectral images recorded for a polystyrene (PS) film in the absorption and emission modes, respectively. Pixel shifting correction and dark background subtraction were applied to those images. In both cases, light colors represent a higher intensity reaching the detector, and the horizontal scale covers a spectral range from approx. 1750 cm⁻¹ to 1000 cm⁻¹. In the absorption mode image of FIG. 1A, a high intensity envelope is observed due to the blackbody emission coming from a broadband infrared source and the dark vertical bands are due to absorption of the infrared light by the PS sample. Some very shallow and narrow bands are also present due to water vapor absorption, since the spectrometer was not purged in any of the experiments presented here. This image is thus similar to a standard single beam spectrum recorded using an FT-IR spectrometer. In contrast, higher intensity appears in the emission image of FIG. 1B at the frequencies where PS emits, and a low intensity background is observed at other frequencies.

It can be observed that the emission and absorption bands appear at the exact same horizontal pixel (wavenumber) positions. Indeed, the infrared emission process involves the same energy levels as the standard absorption phenomenon. While absorption involves the transition of a vibration from a low energy level (typically the ground level) to a higher one, IRES measures the radiation emitted by the relaxation of vibrators from an excited energy level to a lower energy state. Since the selection rules are the same for both processes, similar chemical information can be extracted from absorption and emission spectra.¹¹ A difference between FIGS. 1A and B is the absence of water vapor bands in the emission image since the vast majority of water molecules are found in their ground state at room temperature, and thus can not emit infrared radiation. However, water vapor in the optical path can still absorb the infrared light emitted by the PS sample at frequencies where they overlap, which is why IBES measurements are often carried out with purged instruments.

FIG. 1C shows the emittance and absorptance spectra of the polystyrene film recorded at 120° C. As observed in the spectral images, the band shapes and positions are very similar between the two spectra. This proves that characteristic spectra can be recorded in the emission mode with a PA-IR spectrograph. The intensity of the bands always lies between 0 and 1, as expected. However, quantitative differences are obvious between the two spectra, with weaker bands appearing with a higher relative intensity in the emittance spectrum. This mostly originates from the imperfect nature of the blackbody used as a reference. In fact, using a blackbody spectrum recorded at about 30° C. above the sample temperature makes the emittance and absorptance very similar, as shown by the dotted line in FIG. 1C. Fully quantitative work could thus be realized by using a calibrated commercial blackbody source. It can be noted that no self absorption is observed in FIG. 1C because the temperature of the film was homogeneous across its thickness. When the surface of the sample is colder than its bulk, chemical groups from upper layer that are in their vibrational ground state can absorb photons emitted from the underlying material, leading characteristic bands to show a truncated intensity profile. The signal-to-noise (S/N) ratio of the emission spectrum is excellent.

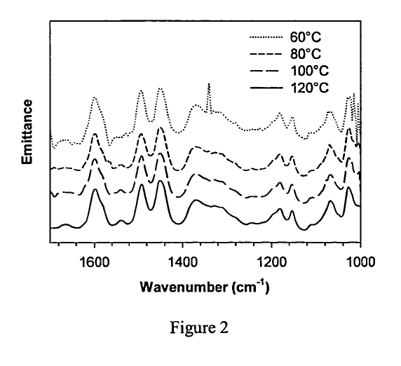

Considering the S/N ratio obtained for a sample maintained at 120° C., the possibility of recording spectra at lower temperatures was explored. FIG. 2 compares the PS emission spectra recorded at temperatures ranging from 120 to 60° C. It is clear that the sample temperature does not influence the peak positions and intensities. This is the expected result from calculations using Eq. 1, in which the sample emittance is ratioed against that of a blackbody at the same temperature. Good quality spectra are obtained at a temperature as low as 80° C., well below the melting point and/or the glass transition temperature of several important polymers such as PS, poly(ethylene terephthalate) (PET), polycarbonate, etc. These results demonstrate that infrared emission spectra can be recorded with PA-IR at sensitivities equal to or better than comparable experiments using FT-IR.

### Example 1

In a first preferred embodiment, when a sufficient S/N ratio can be obtained in a short time at a temperature (or excitation level) of interest, emission spectroscopy can be used to perform both kinetic studies and studies of transient phenomena. For instance, the thermal degradation of various polymers was followed using continuous-scan FT-IR emission spectroscopy by recording spectra in as little as 13 s.⁶ One of the intrinsic advantages of a PA-IR spectrograph as compared to FT-IR spectrometers for the study of non-repeatable phenomena is that its time resolution is dictated only by the frame rate of the FPA, and not by time needed for the reciprocating motion of a moving mirror. Depending on the FPA, frame rates typically range between 17 ms and 600 μs. This time resolution was used in previous studies to follow the reorientation dynamics of liquid crystals exposed to an external electric field.^{13, 15}

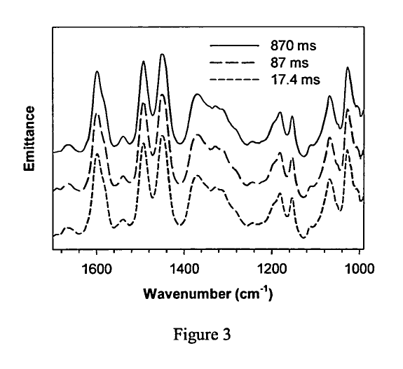

To evaluate the possibility of performing kinetic PA-IRES studies with similar low-millisecond time resolution, measurements were performed using limited time-averaging. FIG. 3 shows PS spectra recorded at 120° C. in 100, 10 and 2 camera frames, corresponding to acquisition times of 870, 87 and 17.4 ms, respectively. The S/N ratio of these spectra clearly indicates that sub-20 ms acquisition times are easily achievable.

### Example 2

In a second preferred embodiment, another IRES application for which ultrafast time resolution would be beneficial is the so-called transient infrared spectroscopy (TIRS) technique.⁸⁻¹⁰ In a TIRS experiment, a moving sample is exposed to a hot (cold) stream of air, thus generating a thin surface layer warmer (colder) than the bulk of the sample. This allows recording emission spectra (hot stream) or absorption spectra (cold stream) of the thin surface layer without the need for a physical contact (such as in attenuated total reflectance spectroscopy), or saturation of the signal due to large thicknesses. TIRS has been applied to the on-line characterization of materials such as polymer extrudates, wood chips, etc. In TIRS, long measurement times directly convert to poor spatial or sample resolution, as a large quantity of material is sampled during each spectrum. The application of a highly sensitive and rapid PA-IR spectrometer to TIRS measurements could thus significantly improve the efficiency of this monitoring technique.

### Example 3

In a third preferred embodiment, aging phenomena in materials often involve a change in material properties resulting from a change in chemical, crystal and/or morphological structure over time scales ranging from milliseconds (for electronic components, e.g., organic light emitting diodes, when they are first turned on) to days (for plastic or ceramic articles exposed to corrosive or aggressive environments). On the shorter end of the time domain the resulting changes could be characterized using a PA-IR spectrograph. For example the intermediate stages of chemical interactions with air in a cyano-acrylate (e.g., Crazy Glue) could be characterized so as to determine, the extent of the molecular kinetics responsible for adhesion. Volatile solvents evaporating from a drying solution or drying paint on a wall would present a time-dependent IR emission spectrum over time and is another example of a sample that changes over time.

### SUMMARY OF INVENTION

While preferred embodiments shown in the results obtained in these preliminary examples suggest that PA-IR spectroscopy could become a powerful tool for performing infrared emission spectroscopy using a variety of methods to produce steady state or transient heating of the sample, whose spectrum is sought. Its advantages, as compared to FT-IR spectrometers, are its ability to work with time dependent sample emission, acquisition times as short as 17 ms, its ruggedness, and the possibility of acquiring spatially-resolved information. This novel approach could prove extremely valuable for emission spectroscopy applications in which sensitivity, time and spatial resolution are important, such as thin films analysis, kinetic studies, and real-time monitoring of far off samples of gas, liquid or solids.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

### REFERENCES

(1) Lisse, C. M.; VanCleve, J.; Adams, A. C.; A'Hearn, M. F.; Fernandez, Y. R.; Farnham, T. L.; Armus, L.; Grillmair, C. J.; Ingalls, J.; Belton, M. J. S.; Groussin, O.; McFadden, L. A.; Meech, K. J.; Schultz, P. H.; Clark, B. C.; Feaga, L. M.; Sunshine, J. M. Science 2006, 313, 635-640.
(2) Kunde, V. G.; Flasar, F. M.; Jennings, D. E.; Bezard, B.; Strobel, D. F.; Conrath, B. J.; Nixon, C. A.; Bjoraker, G. L.; Romani, P. N.; Achterberg, R. K.; Simon-Miller, A. A.; Irwin, P.; Brasunas, J. C.; Pearl, J. C.; Smith, M. D.; Orton, G. S.; Gierasch, P. J.; Spilker, L. J.; Carlson, R. C.; Mamoutkine, A. A.; Calcutt, S. B.; Read, P. L.; Taylor, F. W.; Fouchet, T.; Parrish, P.; Barucci, A.; Courtin, R.; Coustenis, A.; Gautier, D.; Lellouch, E.; Marten, A.; Prange, R.; Biraud, Y.; Ferrari, C.; Owen, T. C.; Abbas, M. M.; Samuelson, R. E.; Raulin, F.; Ade, P.; Cesarsky, C. J.; Grossman, K. U.; Coradini, A. Science 2004, 305, 1582-1586.
(3) Bacsik, Z.; Mink, J.; Keresztury, G. Appl. Spectrosc. Rev. 2005, 40, 327-390.
(4) Bernath, P. F.; Shayesteh, A.; Tereszchuk, K.; Colin, R. Science 2002, 297, 1323-1324.
(5) Heard, D. E.; Brownsword, R. A.; Weston, D. G.; Hancock, G. Appl. Spectrosc. 1993, 47, 1438-1445.
(6) George, G. A.; Celina, M.; Vassallo, A. M.; Coleclarke, P. A. Polym. Degrad. Stab. 1995, 48, 199-210.
(7) Blakey, I.; George, G. A. Macromolecules 2001, 34, 1873-1880.
(8) Jones, R. W.; McClelland, J. F.; Bajic, S. J. In Handbook of Vibrational Spectroscopy; Griffiths, P. R., Chalmers, J. M., Eds.; John Wiley & Sons: Chichester, 2002; Vol. 2, pp 1215-1230.
(9) Jones, R. W.; Meglen, R. R.; Hames, B. R.; McClelland, J. F. Anal. Chem. 2002, 74, 453-457.
(10) Jones, R. W.; McClelland, J. F. Anal. Chem. 1989, 61, 650-656.
(11) Mink, J. In Handbook of Vibrational Spectroscopy; Griffiths, P. R., Chalmers, J. M., Eds.; John Wiley & Sons: Chichester, 2002; Vol. 2, pp 1193-1214.
(12) Griffiths, P. R.; Hirsche, B. L.; Manning, C. J. Vib. Spectrosc. 1999, 19, 165-176.
(13) Pellerin, C.; Snively, C. M.; Chase, D. B.; Rabolt, J. F. Appl. Spectrosc. 2004, 58, 639-646.
(14) Pelletier, I.; Pellerin, C.; Chase, D. B.; Rabolt, J. F. Appl. Spectrosc. 2005, 59, 156-163.
(15) Snively, C. M.; Pellerin, C.; Rabolt, J. F.; Chase, D. B. Anal. Chem. 2004, 76, 1811-1816.

What is claimed:

1. A method to obtain an infrared spectrum using an external sample or substrate on which a sample is placed, coated, deposited, spun on or in some way attached as the source of infrared radiation to produce a time dependent emissive signal that is subsequently detected by an infrared spectrograph equipped with a two dimensional focal plane array.

2. The method of claim 1 further comprising a continuum optical source to provide sample heating in either a pulsed or continuous fashion.

3. The method of claim 1 further comprising a laser (for example, pulsed, continuous, tunable) external source to provide sample heating in either a pulsed or continuous fashion.

4. The method of claim 1 further comprising an external source such as microwave, x-ray, neutron, for example, to provide sample heating in either a pulsed or continuous fashion.

5. The method of claim 1 further comprising a thermal source to provide sample heating in either a pulsed or continuous fashion.

6. The method of claim 1 further comprising abrasion or other friction producing motion to provide sample heating in either a pulsed or continuous fashion.

7. A method to obtain an infrared spectrum using an external sample that is undergoing a chemical reaction and produces an emissive signal that is subsequently changing over time and its spectrum detected by an infrared spectrograph equipped with a two dimensional focal plane array.

8. The method of claim 7 further comprising a continuum optical source to initiate the chemical reaction in either a pulsed or continuous fashion.

9. The method of claim 7 further comprising a laser (for example, pulsed, continuous, tuneable) external source to initiate the chemical reaction in either a pulsed or continuous fashion.
